(19) United States
(12) Patent Application Publication
(10) Pub. No.: US 2024/0338571 A1
(43) Pub. Date: Oct. 10, 2024

(54) TRANSFER LEARNING METHOD FOR A MACHINE LEARNING SYSTEM

(71) Applicant: EATON INTELLIGENT POWER LIMITED, Dublin, 4 (IE)

(72) Inventors: Tony MARRERO, Dublin 7, Dublin (IE); Catriona CLARKE, Kildare, Newbridge (IE); Adi BOTEA, Clonsilla, Dublin (IE); Chahrazed BOUHINI, Dublin 1, Dublin (IE); Suchandra MANDAL, Galway (IE)

(21) Appl. No.: 18/577,549

(22) PCT Filed: Jul. 12, 2021
(86) PCT No.: PCT/EP2021/069256

§ 371 Date: Jan. 8, 2024

(51) Int. Cl. G06N 3/096; G06N 5/02; G06N 20/00

(52) U.S. Cl. CPC G06N 3/096; G06N 5/02; G06N 20/00

(57) ABSTRACT

A transfer learning method for a system including a plurality of existing agents each including a trained machine learning model for modelling a respective existing machine learning scenario, and a new agent. The system includes a database comprising available models for modelling scenarios, including the trained models, existing scenario metadata indicative of existing scenarios, and transfer learning data indicative of parts of the trained models. The method comprises receiving new scenario metadata indicative of a new scenario to be modelled by the new agent, and receiving new scenario training data for training a model of the new scenario. The method also includes querying the database to: select an available model, based on the received data, to model the new scenario; and, select at least some of the transfer learning data, based on the received data, to train the selected model.

### FIELD OF THE INVENTION

The disclosure relates to a transfer learning method for a machine learning system and, in particular, for a system including a plurality of machine learning agents each including a trained machine learning model for modelling a respective existing machine learning scenario. Aspects of the invention relate to a transfer learning method, to a computing device, and to a non-transitory, computer-readable storage medium.

### BACKGROUND

There are a variety of contexts in which a system including a number of different devices may perform respective machine learning tasks for respective scenarios. In one illustrative example, a number of houses may each include a security camera for monitoring an area in the vicinity of the house. In particular, such cameras may include a machine learning (ML) or artificial intelligence (AI) model to perform image processing of the images monitored by the cameras. Such ML models can be trained to recognise certain features in a variety of different situations, for instance recognising individuals from different angles or when their face is partly covered, e.g. when wearing a hooded top.

Training an ML model to exhibit such functionality typically requires a relatively large amount of training data to teach the ML model to recognise features in many different situations. Such training data may not be readily or immediately available, and so training the ML model may take a relatively long time. Furthermore, the computing requirements of the device implementing the ML model may need to be relatively large to train the ML model in this manner.

In a system including a number of devices, a trained model associated with one of the devices can be shared with another one of the devices in order to increase the efficiency of the training process. However, different devices of the system may be required to perform different machine learning tasks and/or the context in which one device is to perform a machine learning task may differ from that of another device of the system, i.e. each device of the system may be required to model a different scenario by means of a ML model.

This means that, while there may be similarities, an ML model of one device trained to model a particular scenario associated with that one device may not be optimal for another device to model another scenario. In the security camera example outlined above, a camera installed in one house may include an ML model trained to recognise features in captured images at that location, whereas that ML model may not be optimal for recognising features in captured images at a different location, e.g. a different part of the country. For instance, there may be a difference in the lighting or background between the different locations in which respective security cameras are installed, meaning that the trained ML model utilised by one camera is not optimal for the other camera to perform the ML task.

Prior systems may therefore suffer the drawback that a training process for ML models implemented by a network of devices, and for modelling different scenarios, may be one or both of inefficient and sub-optimal.

It is against this background to which the present disclosure is set.

### SUMMARY OF THE INVENTION

According to an aspect of the present disclosure there is provided a transfer learning method for a system. The system comprises a plurality of existing agents each including a trained machine learning model for modelling a respective existing machine learning scenario, and comprises a new agent different from the existing agents. The system comprises a database comprising a plurality of available machine learning models for modelling machine learning scenarios, including the plurality of trained machine learning models, existing scenario metadata indicative of one or more features of the existing machine learning scenarios, and transfer learning data indicative of parts of the trained machine learning models associated with respective features of the existing machine learning scenarios. The method is performed by the new agent, implemented on one or more computer processors, and comprises receiving new scenario metadata indicative of one or more features of a new machine learning scenario to be modelled by the new agent, and receiving new scenario training data for training a machine learning model to model the new machine learning scenario. The method comprises querying the database to select one of the available machine learning models to be used by the new agent to model the new machine learning scenario, the selection being based on the received new scenario metadata and the existing scenario metadata, and querying the database to select at least some of the transfer learning data to be used by the new agent to train the selected machine learning model, the selection being based on the received new scenario metadata and the existing scenario metadata. The method comprises training the selected machine learning model using the received new scenario training data and using the selected transfer learning data.

In some examples, querying the database to select one of the available machine learning models may comprise: transmitting the new scenario metadata to the database and, in response, receiving the selected machine learning model from the database; and/or, receiving the plurality of available machine learning models and existing scenario metadata from the database, and comparing the new scenario metadata against the existing scenario metadata to select one of the available machine learning models.

In some examples, querying the database to select at least some of the transfer learning data comprises: transmitting the new scenario metadata to the database and, in response, receiving the selected transfer learning data from the database; and/or, receiving the transfer learning data and existing scenario metadata from the database, and comparing the new scenario metadata against the existing scenario metadata to select at least some of the transfer learning data.

The database may comprise a graph structure linking the existing scenario metadata to the available machine learning models. The new scenario metadata may be compared against the graph structure to select one of the available machine learning models.

The graph structure may comprise: a plurality of nodes each representing an entity associated with the existing scenarios; and, a plurality of edges linking pairs of the entities and representing features of the existing scenarios. The new scenario metadata may be associated with one or more of the nodes by a comparison of features of the new scenario metadata against features represented by the respective edges in order to select one of the available machine learning models.

Each entity may be at least one of: one of the available machine learning models; and, a data source associated with one of the existing scenarios.

The transfer learning data may comprise subsets of data each associated with a respective event of the existing scenarios. In some examples, selecting at least some of the transfer learning data may comprise selecting one or more of the subsets of data based on a comparison between features of the existing and new scenarios.

Each subset of data may comprise at least one of: hyperparameters of the trained machine learning models associated with the respective event; neural network weights of the trained machine learning models associated with the respective event; and, training data used to train the trained machine learning models and associated with the respective event.

The system may be implemented in a communications network comprising a plurality of edge computing devices and at least one cloud-based computing device. Each of the plurality of existing agents and the new agent may be implemented in respective edge computing devices and the database may be implemented in the at least one cloud-based computing device.

According to another aspect of the disclosure there is provided a transfer learning method for a system comprising a plurality of agents each implemented on one or more computer processors and each including a trained machine learning model for modelling a respective machine learning scenario. The method is performed by a first agent of the plurality of agents and comprises receiving new training data different from previous training data used to train the trained machine learning model currently deployed by the first agent. The method comprises retraining the currently-deployed machine learning model using at least the received new training data, comparing the retrained machine learning model against the currently-deployed machine learning model to determine whether to deploy the retrained machine learning model. If it is determined to deploy the retrained machine learning model, then the method further comprises identifying transfer learning data, transfer learning data being data associated with the retrained machine learning model that is not associated with the currently-deployed machine learning model, and transmitting the identified transfer learning data to a database of the system. The database is accessible by second agents, different from the first agent, of the plurality of agents to retrieve the transmitted data for use in retraining the respective trained machine learning models of the second agents.

In some examples, comparing the retrained and currently-deployed machine learning models may comprise determining one or more metrics indicative of performance of the retrained model and comparing against corresponding metrics of the currently-deployed model.

In some examples, identifying transfer learning data comprises identifying data in the received new training data that is different from the previous training data. The identified different data may be identified as transfer learning data if a difference between the identified different data and the previous training data is greater than a prescribed threshold.

In some examples, identifying transfer learning data may comprise identifying model weights of the retrained machine learning model different from corresponding model weights of the currently-deployed machine learning model. The identified model weights may be identified as transfer learning data if a change in the identified model weights caused by retraining is greater than a prescribed threshold.

The method may comprise transmitting scenario metadata to the database along with the identified transfer learning data, the scenario metadata being indicative of a feature of the machine learning scenario being modelled by the first agent associated with the identified transfer learning data.

In some examples, retraining the trained machine learning model may comprise using at least some of the previous training data.

According to another aspect of the disclosure there is provided a transfer learning method for a system comprising a plurality of agents each implemented on one or more computer processors and each including a trained machine learning model for modelling a respective machine learning scenario. The method is performed by a first agent of the plurality of agents and comprising querying a database of the system to obtain transfer learning data, the transfer learning data being data not associated with the trained machine learning model that is currently deployed by the first agent. The method comprises updating the trained machine learning model of the first agent using the obtained transfer learning data, comparing the updated machine learning model against the currently-deployed machine learning model, and determining whether to deploy the updated machine learning model based on the comparison.

The obtained transfer learning data may be new training data different from previous training data used to train the currently-deployed machine learning model. In some examples, updating the trained machine learning model may comprise retraining the trained machine learning model to obtain the updated machine learning model.

In some examples, retraining the trained machine learning model may comprise using at least some of the previous training data used to train the currently-deployed machine learning model.

The obtained transfer learning data may be one or more updated parameters of the machine learning model different from corresponding parameters of the currently-deployed machine learning model. In some examples, updating the trained machine learning model may comprise replacing one or more parameters in the trained machine learning model with the corresponding received updated parameters.

In some examples, comparing the updated and currently-deployed machine learning models may comprise determining one or more metrics indicative of performance of the updated model and comparing against corresponding metrics of the currently-deployed model.

According to another aspect of the disclosure there is provided a non-transitory, computer-readable storage medium storing instructions thereon that when executed by one or more computer processors cause the computer processors to execute any of the methods described above.

According to another aspect of the disclosure there is provided a computing device comprising one or more processors configured to perform any of the methods described above.

### BRIEF DESCRIPTION OF THE DRAWINGS

Examples of the disclosure will now be described with reference to the accompanying drawings, in which:

FIG. 1 schematically illustrates a machine learning system in accordance with an aspect of the disclosure and, in particular, illustrates data flow between different components of the system, including cloud-based and edge computing-based components;

FIG. 2 schematically illustrates cloud-based and edge computing-based components of the system of FIG. 1;

FIG. 3 illustrates method steps to add a new edge computing-based component to the machine learning system of FIG. 1;

FIG. 4 illustrates method steps to create a central database in a cloud-based component of the system of FIG. 1;

FIG. 5 illustrates method steps performed by the new edge computing-based component of FIG. 3 to train the component to model a new machine learning scenario;

FIG. 6 illustrates method steps to determine whether to transfer data from an edge computing-based component to a cloud-based component of FIG. 1;

FIG. 7 illustrates method steps performed by an edge computing-based component of FIG. 3 to determine whether to transmit new data of the edge computing-based component to a cloud-based component of the system;

FIG. 8 illustrates sub-steps of one of the steps of FIG. 6;

FIG. 9 illustrates sub-steps of another one of the steps of FIG. 6;

FIG. 10 illustrates method steps to determine whether to transfer data from a cloud-based component to an edge computing-based component of FIG. 1;

FIG. 11 illustrates method steps performed by an edge computing-based component of FIG. 3 to determine whether to update a machine learning model of the component using data received from a cloud-based component of the system; and,

FIG. 12 illustrates sub-steps of one of the steps of FIG. 10.

### DETAILED DESCRIPTION

The present disclosure describes a transfer learning method for sharing data and knowledge between different devices of a machine learning system in which each device is configured to perform a machine learning task associated with a respective scenario of the device. In particular, the data and knowledge is shared in a manner that allows new devices added to the system to be trained in an efficient and optimal way, and to update existing devices regularly or continuously in an efficient way to optimise their training for their respective machine learning task. The means by which these advantageous features and effects are achieved will become apparent throughout the description of illustrative examples of the disclosure below.

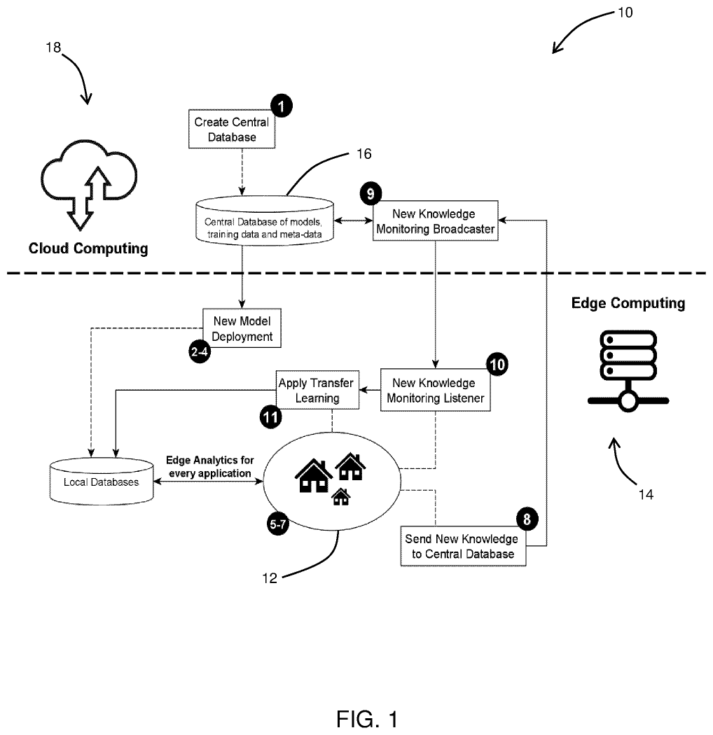

FIG. 1 schematically illustrates an example of a machine learning system 10 in accordance with the disclosure. In particular, FIG. 1 illustrates data flow between different components of the system 10, and illustrates where computations of the system may be performed. The system 10 includes a number of components in communication with one another over a network, e.g. a wireless communications network. The system includes one or more cloud-based components and one or more edge computing-based components. That is, the system 10 includes a number of distributed computing devices 12 in the edge computing domain 14, where each device 12 executes a machine learning (ML) algorithm or model to perform an ML task using local processing capabilities. The system 10 also includes a central database 16 in the cloud computing domain 18 for storing knowledge and information related to the devices 12 and their ML models, and which can communicate with the edge devices 12.

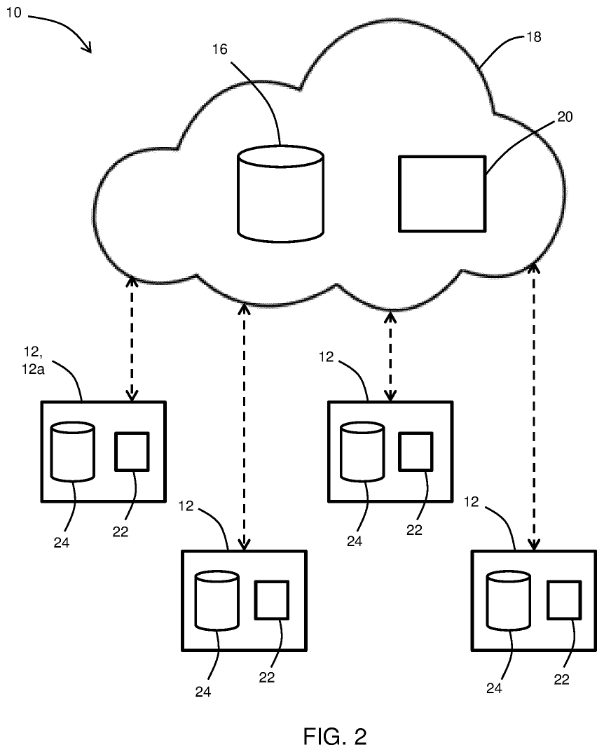

With additional reference to FIG. 2, in addition to the central database 16 the cloud computing domain 18 can also include computational processing capabilities in the form of one or more cloud-based computer processors 20 for performing various calculations or processes in connection with operation of the system 10. Each of the edge devices 12—or machine learning agents 12—in the edge domain 14 include one or more (local) computer processors 22 for implementing the ML task to be performed by the respective device or agent 12. Each device 12 may also include one or more locally-accessible databases 24 to store data or other knowledge associated with the ML model used by each device 12 to perform the respective ML task.

For illustrative purposes, an example in which the system 10 includes a number of houses or other buildings each including one or more security cameras—or surveillance cameras, closed-circuit television (CCTV) cameras, etc.—is described. However, it will be understood that this described example is non-limiting and that the arrangement and methods described herein are applicable to many different applications or examples.

In this example, there is a local computational device or ML agent 12 associated with the camera of each building. Each agent 12 receives image data from the respective camera and is configured to perform an ML task based on the received image data. For instance, in one example the ML task may be to perform feature recognition or extraction on the image data, where the feature may be the face of a person in the image data.

Each agent 12 uses a trained ML model-implemented on the one or more processors 22 of the respective agent 12—to perform the ML task. Each house in the system 10 may be in a different geographical location with different weather conditions, different sunrise/sunset times, etc. Also, each camera may be monitoring an area with different characteristics, e.g. one camera may be monitoring an area of grass whereas another camera may be monitoring a paved area. Different ones of the agents 12 may also be configured to perform different ML tasks, e.g. facial recognition, movement tracking, etc. Each agent 12 of the system 10 may therefore be regarded as being for modelling a different ML scenario, where the scenario can be defined by the particular ML task and/or context of the agent 12 under consideration.

With this in mind, an ML model that is trained in an optimal manner for use in one ML scenario of the system 10 may not be optimal for use in another ML scenario of the system 10. Nonetheless, there may be similarities between the different ML scenarios of different agents 12 in the system 10, and so it would be beneficial for training data and knowledge to be shared between agents 12 of system 10, where appropriate, to increase training efficiency and ML model accuracy.

Whereas prior arrangements may provide for some degree of transfer learning between agents in a system, this has tended to focus on transfer of data from a single source to a single recipient as a one-off process. In the present disclosure, transfer learning methods are described in which knowledge can be transferred between multiple agents in a system, where only knowledge that is useful to particular agents is transferred and/or used by those agents, and where transfer learning can occur as part of both: an initial phase, where a new agent is added to a system of agents and where an initial transfer of knowledge allows initial training of the new agent to be performed; and, a dynamic phase, where agents in a system learn or acquire knowledge continuously or at certain intervals as they operate in their respective environments. This will be discussed in greater detail below.

A transfer learning method for the system 10 during an initial transfer phase when a new agent or device 12a is added to the plurality of trained agents 12 already in the system 10 is described first. The new agent 12a is for modelling a new ML scenario, and so a new ML model needs to be trained to be implemented by the agent 12 to model the new ML scenario. Each of the trained agents 12 implement respective trained ML models for modelling respective existing ML scenarios.

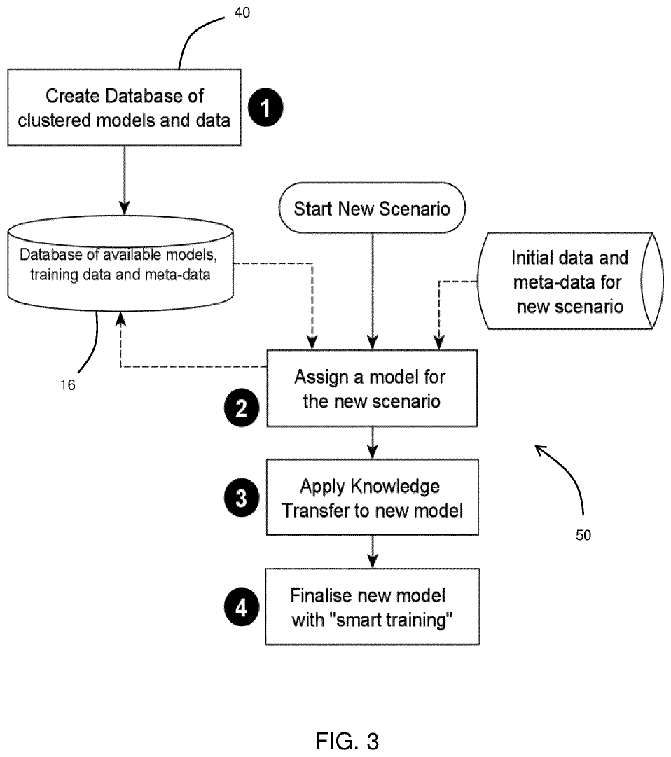

With additional reference to FIG. 3, the central database 16 (located in the cloud domain 18) of the system 10 stores data relating to each of trained agents 12 and respective existing ML scenarios. In particular, the database 16 includes model data indicative of the trained models of each of the trained agents 12. For instance, this can include data indicative of the architecture of the ML model—e.g. a neural network architecture, number of layers, number of neurons, etc.—and other parameters (e.g. weights) and hyperparameters of the trained models. This can also include data indicative of the context, environment, and/or the ML task to be performed, of respective existing scenarios of the trained agents 12. Data relating to the model, environment, context, etc. of a scenario modelled by a particular agent 12 may be regarded as being metadata of that particular scenario. Furthermore, the database 16 includes training data that has been used to train the trained ML models of the respective trained agents 12. As illustrated in FIG. 2, each agent 12 can communicate with the database 16 to transmit data to, or receive data from, the database 16.

The database 16 includes details of a plurality of available ML models that are to be used by agents 12 in the system 10 to model their respective ML scenarios. These stored plurality of available ML models can include details of trained ML models currently deployed by trained agents 12 of the system 10. The plurality of available ML models can also include other trained ML models not currently deployed by any of the trained agents 12, or architectures of ML models that are not yet trained.

The models, metadata and training data stored in the central database 16 may be arranged in a manner in which it can be determined which of the stored information may be of use in training the new agent 12a. In one example, the information of the system 10 can be structured in the form of a knowledge graph, with nodes representing entities and edges representing relationships between entities. Entities may be available ML models and/or a data source associated with one of the existing scenarios, for instance. In another example, the information of the system 10 may be structured in clusters of models and data, with entities being grouped based on similarity of data.

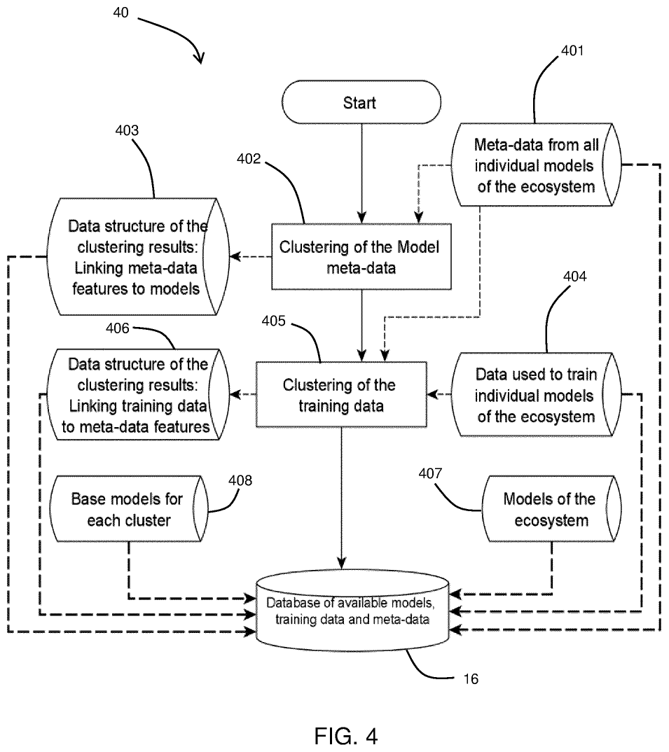

FIG. 4 illustrates one example of how the database 16 may be created and arranged in a manner that information about trained models and existing scenarios of the system 10 may be used to train a new agent 12a. The main knowledge database creation may take three main inputs as mentioned above: the initial pre-trained models of the system 10, their meta-data, and the training data used to train them. Two outputs may then be created as part of the database creation: a clustered data structure or knowledge graph of the model metadata; and, a clustered data structure or knowledge graph of the training data. Each of these inputs and outputs may then be combined to be part of the main knowledge database 16 of the system 10.

With reference to FIG. 4, the database 16 receives or acquires 401 the metadata associated with existing scenarios of the system 10, i.e. metadata associated with models, contexts, etc. of the existing trained agents 12 of the system 10. This metadata is clustered 402 to create an organised data structure 403 for the models by analysing their associated metadata. This analysis may take the form of generating a knowledge graph, or make use of any other relevant data clustering technique. Each node of such a graph may represent an ML model, for instance, and the edges of the graph may represent relational semantic information from the metadata. In the security camera illustrative example, such metadata could include home location, home size, a task to be performed by the model, key performance indictors (KPIs) of an agent 12, etc. The nodes may not only represent ML models, but instead the knowledge graph may be a heterogeneous graph with various types of nodes and links permitted.

The database 16 receives or acquires 404 the training data associated with existing scenarios of the system 10. This is analysed along with the metadata mentioned above to cluster 405 the training data to create an organised data structure 406 for the training data. This analysis may take the form of generating a knowledge graph or any other relevant data clustering technique. Each node of the graph may represent a data source, and the edges of the graph may represent semantic event information from the metadata. In the security camera illustrative example, such an event may be that an alarm of the home has been set off, or that the home is vacant, e.g. the occupants are away on holiday, or that a new object has been detected (e.g. a different type of bird from what has been detected previously).

These data structures 403, 406 form part of the central database 16 along with the existing scenario metadata, existing scenario training data, trained ML models 407 of the system and base models 408 of the system 10 (e.g. model architectures to be trained to model particular scenarios).

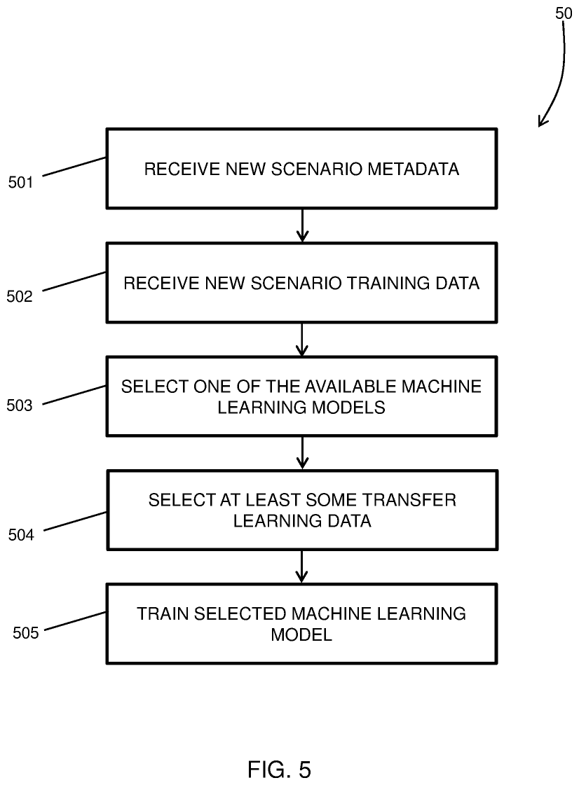

With reference to FIGS. 3 and 5, once the central database 16 has been created a method 50 for adding a new ML agent 12a to the plurality of ML agents 12 in the system may be performed. In particular, knowledge and information from the existing scenarios modelled by the existing ML agents 12 is stored and arranged in the central database 16 so that it can be used by the new ML agent 12a to model an associated new scenario. FIG. 5 shows the steps performed by the new agent 12a-specifically, one or more computer processors implementing the new agent 12a—to train an ML model to perform an ML task associated with the new agent 12a.

At step 501 of the method 50, the new agent 12a receives new scenario metadata indicative of one or more features of a new machine learning scenario to be modelled by the new agent 12a. In the security camera example, the new agent 12a may correspond to a security camera being installed at a new/different house or building, where the new agent 12a needs to perform an ML task associated with monitored image data collected by the camera, e.g. face detection analysis. In this case, the features included in the metadata may include details such as a geographical location of the home, a type of background of a monitored area/region of the camera, a specification of the installed camera, a type/quality of image data that is collected, the ML task to be performed, etc.

At step 502 of the method 50, the new agent 12a receives new scenario training data for training an ML model to model the new machine learning scenario. This may be data provided with the new agent 12a to train the ML model, e.g. a standard training data used to train all new agents of a particular type, and/or training data specific to the new scenario under consideration. In the security camera example, the training data may include input/output pairs for an ML model such as a neural network, where the input is part or all of an image captured by the camera and the output is a result of a facial detection task, e.g. indicating whether the captured image contains a human (rather than an animal, for instance).

At step 503 of the method 50, the new agent 12a queries the central database 16 to select one of the available machine learning models to be used by the new agent 12a to model the new machine learning scenario. This selection is made based on the received metadata associated with the new scenario (as mentioned above) and on the existing scenario metadata stored in the central database 16. This selection may be regarded as selecting a base ML model which may then be further tuned to new scenario.

The processing to make this selection may be performed in the edge domain 14, i.e. by the new agent 12a. In such a case, querying the database 16 to select one of the available machine learning models may include details of the available ML models and existing scenario metadata being transmitted from the database 16 to the new agent 12a. The new agent 12a may then compare the new scenario metadata against the received existing scenario metadata to select one of the available machine learning models. Alternatively, the processing to select an ML model may be performed in the cloud domain 18, i.e. by a processing device 20 in the cloud. In such a case, querying the database 16 to select one of the available ML models may include transmitting the new scenario metadata from the new agent 12a to the cloud 18. A comparison between the new scenario metadata and existing scenario metadata in the central database 16 may then be performed in the cloud domain, with details of the ML model that is selected based on the comparison then being transmitted from the cloud 18 to the new agent 12a.

In one example, the processing to select an available ML model to model the new scenario of the new agent 12a may involve querying the high-level features of the new scenario's metadata into the main knowledge graph's data structure 403 of the models, and selecting an optimal node in the knowledge graph by performing link-based clustering. Link-based clustering is a technique for grouping entities based on the similarity of their links. Each node in the graph may represent an available ML model of the system 10. When the optimal or most appropriate ML model is assigned or selected to the new scenario, this ML model may be copied and added to the graph as a new node.

In another example, an ML model for the new scenario may be assigned by identifying the entity most similar to the new scenario and assigning it that entity's ML model. This is determined by first obtaining the cluster in the data structure 403 with the highest similarity score according to an appropriate metric, above a predefined confidence, with the new scenario, and then selecting the entity within that cluster that individually has the highest similarity score with the new scenario.

It may be that if no cluster meets the predefined confidence level, then a new cluster is created with the new scenario's metadata to create a new entity in the data structure 403. If, however, the new scenario has only a partial/empty list of features, or the features are not comparable with entities in the data structure 403 (making it difficult to compute similarity scores), then the relevance of various features within the knowledge bases of all clusters of the data structure 403 may be used to create an ML model for the new scenario. The system 10 can elicit such information, whereby metadata features may be added in decreasing order of importance to the new scenario until a stopping criterion is met. Once an ML model is assigned to the new scenario, it may be added to the data structure 403 within the cluster to which it is most similar.

At step 504 of the method 50, the new agent 12a queries the central database 16 to select transfer learning data to be used by the new agent 12a to train the ML model selected in step 503. The selection of transfer learning data is based on the metadata associated with the new scenario and the metadata associated with the existing scenarios. This step allows for fine-tuning of the ML model that is chosen or selected in step 503 to be more appropriate or optimal for specifically modelling the new scenario under consideration by the new agent 12a. This may be achieved by applying adequate transfer learning from the main knowledge database 16 to the selected ML model. In particular, the ML model selected from the available ML models may not be completely optimal for describing the new scenario, and so knowledge or information from other ones of the available ML models, e.g. hyperparameters, neural network weights, specific training data, etc. associated with certain features or events of the existing scenarios, may be selected and transferred to the selected ML model in order to increase its accuracy in describing the new scenario. That is, metadata of existing scenarios indicating certain features or events of the existing scenarios may be linked to certain parts of the existing trained ML models or to training data used to train the existing trained ML models, such that a comparison of existing scenario metadata against the new scenario metadata allows for the identification of those parts of the existing ML models, or associated training data, that would be relevant to the new/selected ML model for describing the new scenario. This data (model parameters, certain training data, etc.) that may be identified in existing ML models as relevant to the new ML model may be referred to as transfer learning data. The transfer learning data may be in the form of subsets of data each associated with a respective event of the existing scenarios, where one or more of the subsets of data may be selected for use in the new/selected ML model from step 503 based on a comparison between features of the existing and new scenarios, e.g. via a comparison of metadata.

In one example, knowledge graphs may be utilized for this transfer learning task, as the graphs can include various types of semantic hierarchies which can be leveraged to select and distribute appropriate knowledge amongst the nodes. In another example, knowledge, e.g. specific training data from an existing scenario, may be transferred by obtaining a distance metric, e.g. cosine distance, Euclidean distance, etc., between each of the features in the new scenario and each of the features of the entities within the same cluster. If the distance of any feature pair is small, then that may imply that the pairs are similar, and that knowledge related to that feature is relevant to the new scenario and should be transferred.

In an example in which the selected ML model is a deep learning model, the mechanism that facilitates transfer learning may be formulated during the training of the individual initial/existing ML models of the system 10. During training, the data is classified into various categories. For instance, in the security camera example, these categories may be regarded as events, e.g. the event of the homeowners going or returning from holidays, etc. During training, each model may be orchestrated to modify its neurons in a way that encourages specific neural pathways that are as much as possible independently responsible for the aforementioned event categories. The purpose is to segment and identify which neural pathways are responsible for specific activities, and to semantically classify these activities. Once these activities are semantically tagged, they can be included in the metadata of the model, and they can be categorized as ‘knowledge’. One way to transfer this knowledge to a new model, e.g. the selected model for the new scenario, is to copy the neural weights that were associated with that particular knowledge, or to utilise the data, e.g. training data, that was responsible for that particular knowledge. The new model can therefore both initialise itself with specific neuron weights that were transferred from another model and can also then be trained on specifically selected data which then would modify the model's weights naturally during training.

Neural pathways may be determined by analysing the activations of the neurons of the ML model when the data from each event category is passed through the ML model. It is possible to restrict which neural pathways are associated with an event by ‘freezing’ the unwanted neurons, and only updating the weights of chosen neurons with selected data. Neural networks cannot always be segregated in this way and neural pathways may overlap in their effect on various event categories. Nonetheless, semantically tagging neural pathways to events and to knowledge allows for better transfer learning compared to randomly initialising the neural weights of a new deep learning model. In a scenario in which knowledge is in the form of data and not weights, it can be selected which neurons of the new ML model will be updated while retraining on the new data (knowledge).

Similarly to step 503, the processing to select transfer learning data may be performed locally by the new agent 12a in the edge domain 14, or performed in the cloud domain 18. In a case in which the processing is performed locally, this querying step may include the new agent 12a receiving the transfer learning data and existing scenario metadata from the central database 16, and then comparing the new scenario metadata against the existing scenario metadata to select at least some of the transfer learning data. In a case in which the processing is performed centrally in the cloud 18, this step may include the new agent 12a transmitting the new scenario metadata to the cloud 18, where a processing device 20 in the cloud domain 18 compares the new scenario metadata with existing scenario metadata from the database 16 in order to select transfer learning data. This selected data is then transmitted from the cloud domain 18 to the new agent 12a.

At step 505 of the method 50, the new agent 12a trains the ML model selected in step 503 using the received new scenario training data from step 502 and using the selected transfer learning data from step 504. Note that the selected ML model may be a (previously) trained model, e.g. that is used by one of the existing agents 12, that is retrained using the abovementioned, newly-acquired data, or an untrained model architecture that is trained using this acquired data. Either way, the new scenario is modelled by the new agent 12a by first selecting a base ML model that is available in the system 10, and then tuning this base ML model to be more suitable for modelling the new scenario by using the selected transfer learning data available in the system 10.

Referring back to FIG. 1, during operation of the agents 12 of the system 10, new knowledge that is acquired or developed by one of the agents 12 may be transmitted from the agent 12 to the central database 16. This new knowledge may then be shared, as appropriate, amongst one or more of the other agents 12 in the system 10 so as to improve the accuracy of the respective ML models in modelling the respective ML tasks of the agents 12.

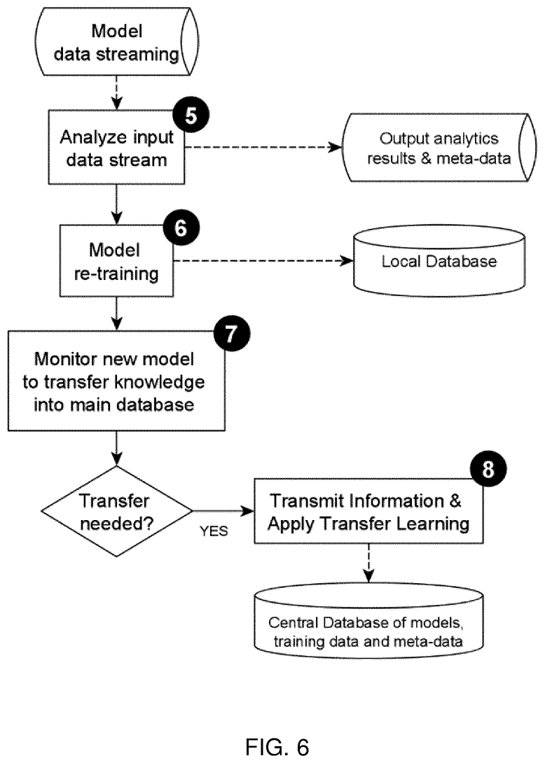

FIG. 6 outlines the flow of information that may occur in the system 10 when new knowledge that is acquired by an agent 12 is to be used by said agent 12 and/or shared within the system 10. The agents 12 continue to receive new data as part of their operation, with the new data stream being used to retrain the respective ML models at various times (e.g. after a predefined amount of time, when new data has caused the current ML model to be ineffective, when new ground truth information for the new data is available, etc.). It is then determined whether recent knowledge or data is worthwhile sharing with the rest of the system 10, so that other agents 12 can also benefit.

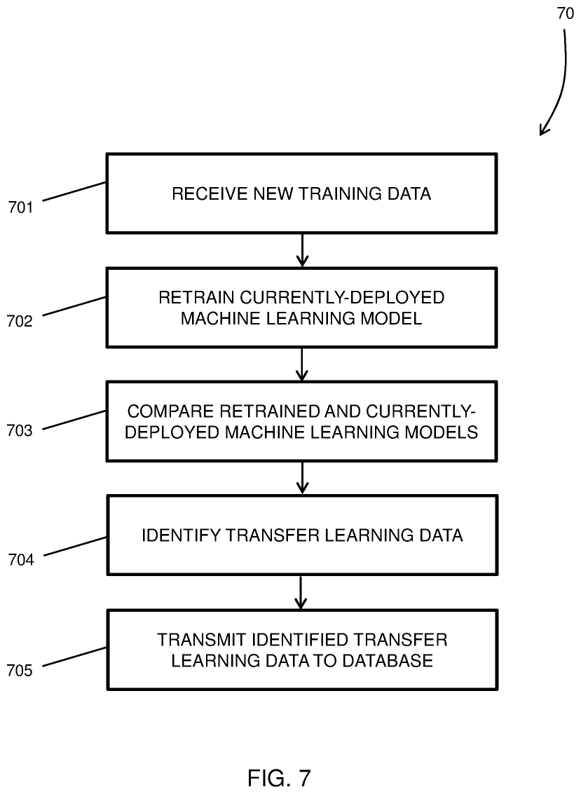

FIG. 7 shows steps of a method 70 performed by one of the ML agents 12 (a ‘first’ ML agent) when new knowledge or data is acquired. At step 701, the first ML agent 12 receives new training data different from previous training data used to train the trained ML model currently being deployed by the first agent 12 to perform the ML task associated with the first agent 12. This new data may be acquired in any suitable way, e.g. by user input to label certain data. The new data may correspond to a rare event or occurrence, e.g. an anomalous situation, which is not covered by the previous training data, and so for which the currently-deployed ML model of the first agent 12 is not directly trained to recognise or process. If the new data corresponds to an anomalous event, then it may be more likely that other agents 12 of the system 10 also have not experienced such an event, meaning that the corresponding deployed ML models are also not trained for such an event.

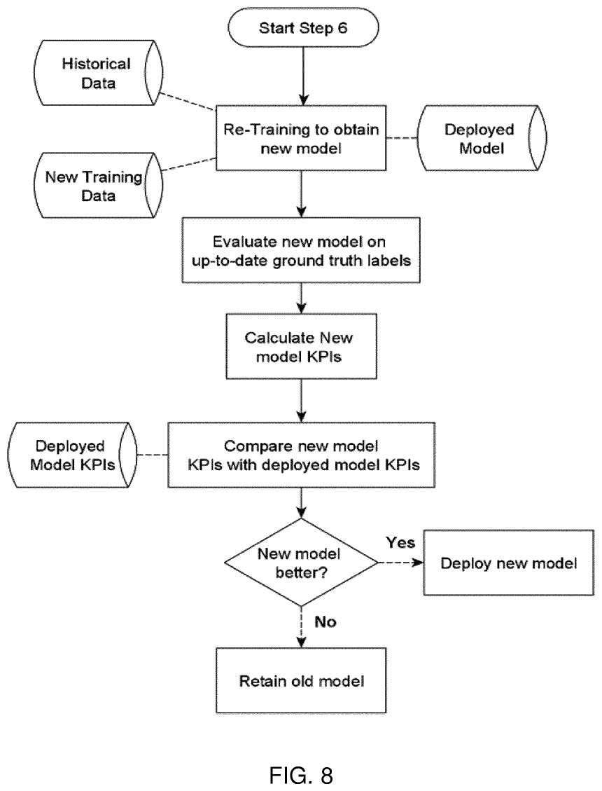

At step 702 of the method 70, the first ML agent 12 retrains its currently-deployed ML model using at least the received new training data. With additional reference to FIG. 8—which further details steps of the method 70—the first agent 12 may use previous or historical training data as well as the new training data to retrain the currently-deployed model to obtain a retrained or new ML model.

At step 703 of the method 70, the first ML agent 12 compares the retrained ML model against the currently-deployed ML model to determine whether to deploy the retrained ML model. That is, the first agent 12 makes some assessment of whether the retrained model is in fact better than the currently-deployed ML model in order to determine which model to continue operation with. With reference to FIG. 8, to achieve this the first agent 12 may evaluate the retrained or new ML model based on up-to-date ground truth labels, i.e. based on labelled data with known outcomes, so that the model accuracy can be analysed. One or more key performance indicators (KPI)—i.e. model accuracy, etc.—of the retrained ML model may then be determined by the first agent 12, and compared against the KPIs of the currently-deployed model to determine which model to retain for ongoing operation. The comparison between new and existing models may involve running each model using the historical data.

If it is determined to retain the currently-deployed ML model on the basis of the comparison, then the process may end as it may be decided that it would not be appropriate or useful to share the new training data throughout the system 10. On the other hand, if it is determined to deploy the retrained or new ML model, then the method 70 includes a step 704 of identifying transfer learning data associated with the retrained ML model for sharing throughout the system 10. Such transfer learning data may be data that is not associated with the currently-deployed ML model, and so may be data that is not available or known to other agents 12 of the system 10, but which may be of use to them.

The transfer learning data may be in the form of model data, e.g. parameters such as model weights, and/or some or all of the new training data used to train the new model. The transfer learning data may include data associated with certain events or features. For instance, if the new training data is associated with a particular event of the scenario under consideration by the first agent 12, then this information may be captured as part of the transfer learning data. This may assist in determining whether other agents 12 can make use of this new training data to improve their respective currently-deployed ML models.

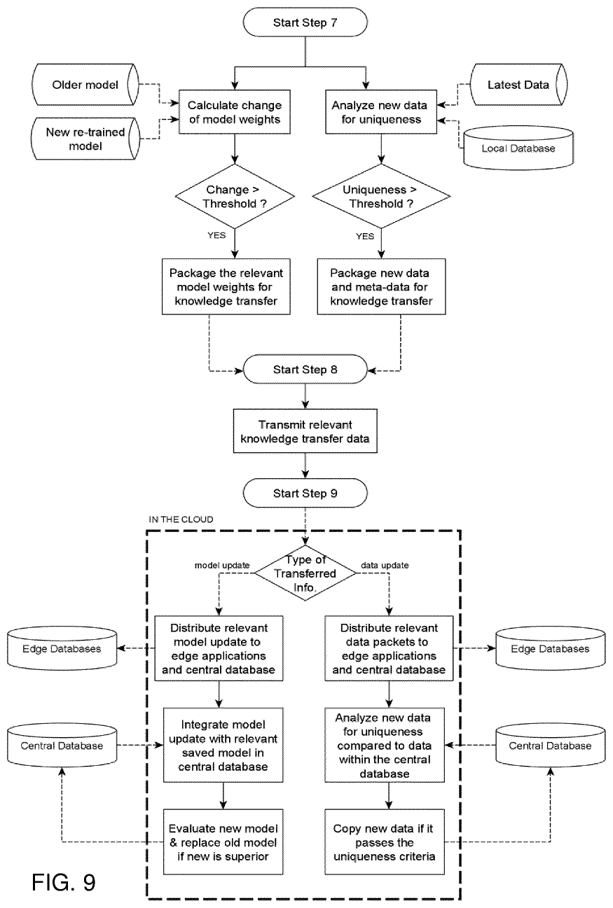

With reference to FIG. 9, the identification of transfer learning data can include an analysis of changes to the parameters/weights of the ML model and/or an analysis of the new training data. For instance, a comparison of weight values between the old and new (retrained) ML models may identify those parts of the model which have changed significantly as a result of the new data. This may be determined with reference to a predefined threshold difference: those model weights that have changed by at least a threshold amount are grouped as being appropriate for knowledge transfer across the system 10. As another example, the new training data may be analysed to identify which parts thereof differ by at least a prescribed threshold amount relative to the data that was already available to the first agent 12. In one example, this may be achieved via a pairwise comparison of records from the new or recent training dataset and records in the historical training data, where two records may be compared via a distance function such as the cosine distance. The new training dataset may be decided to be significantly different if at least a certain number of records are at least a certain minimum distance from each of the historical training records. In other examples, other methods to decide on the ‘uniqueness’ of the recent training data may be used. Those identified (‘unique’) sets of data may similarly be grouped and as being appropriate for knowledge transfer across the system 10.

At step 705 of the method 70, the first agent 12 transmits the identified transfer learning data to the central database 16 of the system 10. The database 16 is accessible by, and in communication with, the other ML agents 12 of the system 10 such that the transfer learning data transmitted to the cloud 18 by the first agent 12 can be retrieved by the other agents 12 for use in retraining the respective trained ML models.

FIG. 9 illustrates how transfer learning data received from the first agent 12 may be processed in the cloud domain 18, for instance by a processing device 20. This processing is responsible for routing the new information to other edge devices (agents) 12 (for instance, to the local databases 20) of the system 12 and integrating it to the central database 16. If the new knowledge to be transferred is in the form of a model weight update, then it will be shared with the central main database 16 and distributed to edge applications (agents) 12. One or more of the available ML models stored in the central database 16 may also be updated with the model weight updates. A determination as to whether to update the stored models in such a manner may be performed in a corresponding manner to the comparison (performed by an edge device 12) between retrained and currently-deployed ML models in step 703 of the method 70. Only if the updated model is determined to be better or superior in some way, e.g. prediction accuracy, are details of the updated model stored in the central database 16.

If the new knowledge is in the form of data, e.g. training data, then this data may be shared with one or more of the local agents 12 and with the central main database 16. Individual agents 12 may then decide if and how to update their own, currently-deployed ML models based on the new knowledge received. Regarding the update of any relevant models/data within the central database 16 itself with the new information, the process may be performed in a corresponding manner to the comparison (performed by an edge device 12) between retrained and currently-deployed ML models in step 703 of the method 70.

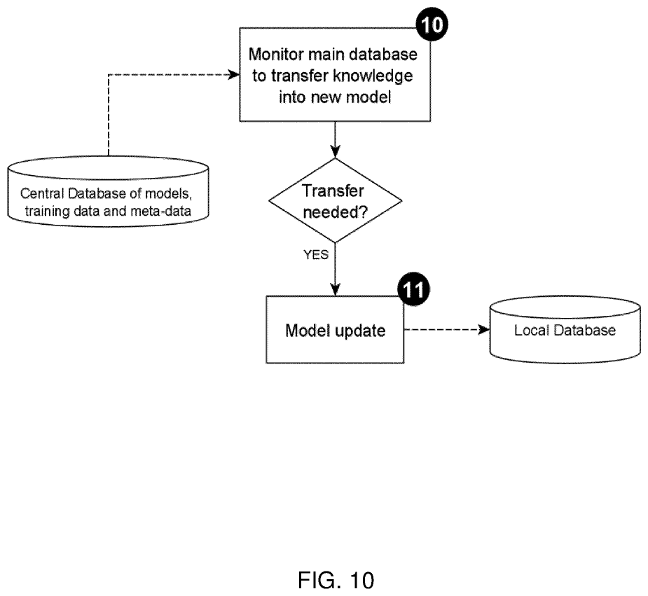

Referring back to FIG. 1, during operation of the agents 12 of the system 10, each agent 12 may monitor the central database 16 for available model updates that could be used to improve the respective currently-deployed ML models. With reference to FIG. 10, it may be determined in the cloud domain whether there is transfer learning data that should be made available to local agents 12, and the local agents 12 may make individual determinations as to whether to incorporate available transfer learning data from the cloud database 16 into the respective local database 22 (and to update the respective ML models).

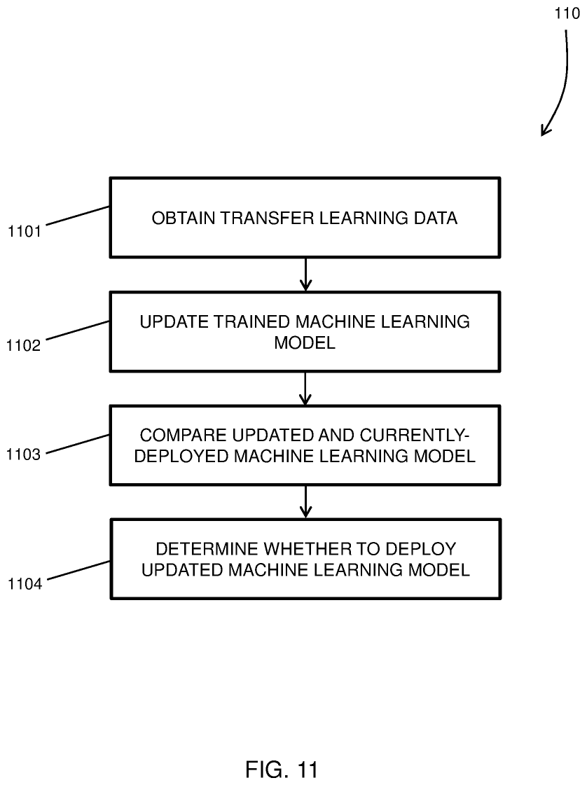

FIG. 11 illustrates steps of a method 110 performed by one of the ML agents 12, e.g. a first agent 12, to determine whether to incorporate available transfer learning data from the cloud 18 into the deployed ML model of the first agent 12. At step 1101, the agent 12 queries the central database 16 of the system 10 to obtain transfer learning data. The transfer learning data is data not associated with the trained ML model that is currently deployed by the first agent 12. Similarly to above, two types of information that may be transferred are data and model updates (which includes model weights, new system parameters, rules and heuristics, etc.). If the new information to be transferred from the central database 16 is in the form of data, an evaluation of this data similar to above may be performed to evaluate its uniqueness compared to the historical data of that application 12. The metadata of the new information may first need to be verified, with only relevant data being transferred if it satisfies certain uniqueness criteria. If the information to be transferred is in the form of a model update, then the application 12 may first verify the validity of the incoming model update metadata and may only be considered if the model update is compatible with the deployed ML model of the application 12. Corresponding metrics to those mentioned above may be used to compare the distance of the new model updates with that of the deployed model. If the new model update is sufficiently different then it may be considered for updating the currently deployed model.

At step 1102, the first agent 12 updates the currently-deployed trained ML model using the obtained transfer learning data. This can involve retraining the trained ML model to obtain the updated ML model. At least some of the previous training data used to train the currently-deployed ML model may be used as part of this. The obtained transfer learning data may be in the form of one or more updated parameters of the ML model different from corresponding parameters of the currently-deployed ML model. In such a case, updating the trained ML model may include replacing one or more parameters in the trained ML model with the corresponding received updated parameters.

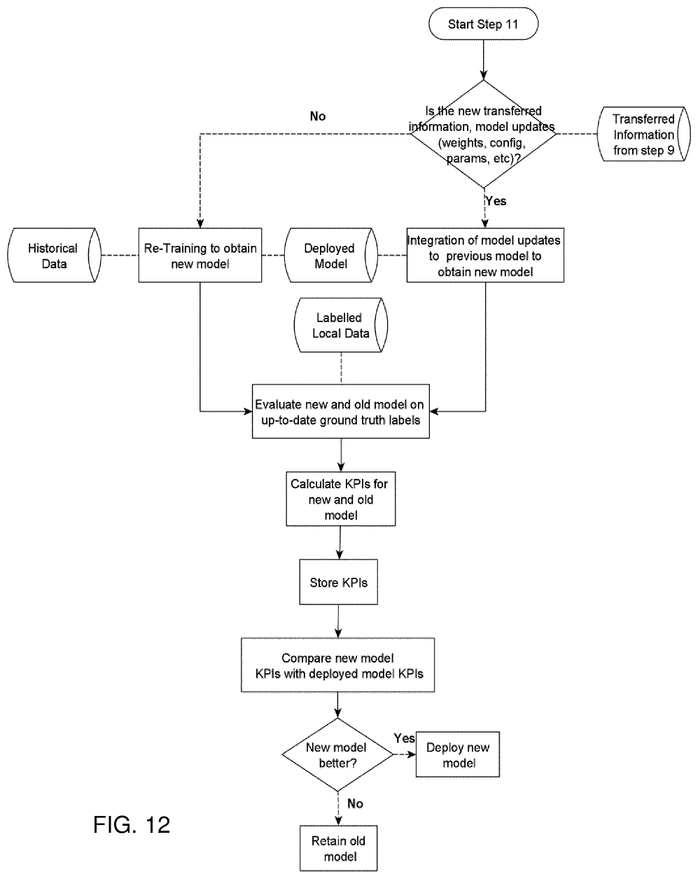

At step 1103, the first agent 12 compares the updated ML model against the currently-deployed ML model in a similar manner to the above description. At step 1104, the first agent 12 determines whether to deploy the updated ML model based on the comparison. For instance, the updated model may be deployed only if is determined to be an improvement, e.g. according to some metrics, over the current model. These steps are further detailed in FIG. 12. Other new information (data, parameters, etc.) may be copied to the local database 24 of the application 12 and can replace existing items, as appropriate.

Many modifications may be made to the described examples without departing from the scope of the disclosure as defined in the appended claims.

Although an example in which the system includes performing ML tasks associated with image data collected by a number of security cameras, e.g. facial recognition tasks, it will be appreciated that the described system and methods are applicable to many different machine learning applications. For instance, in one example the system may include a number of ‘smart’ homes each including a number of connected devices or appliances.

In such an example, a knowledge graph may be built which maps all of the rational connections between the homes in the system. A new ‘smart’ home may then be added to the graph and the system can use link-based clustering, for instance, to determine which of the ML models associated with the current homes matches closest to the new home. This test may be based on a similarity metric across all rational links of the new home to the graph's other entities. Rational links can refer to features such as similar appliances, similar profiles of people staying in the corresponding homes, similar size/characteristics of homes, their energy usage, and similar patterns of appliance usage, whether the model's purpose is classification or forecasting, etc.

The six homes could alternatively be clustered using a clustering technique such as K means, a self-organising map technique, etc. with the data features and model metadata being provided as input. These could be grouped into two clusters, for instance. If a new smart home is added into the system, then it may first be checked which of the two clusters the new home should belong. This test may be based on a similarity metric. Such a metric can refer to similar features, such as similar appliances, similar profiles of people staying in the corresponding houses, their energy usage, and similar patterns of appliance usage, etc. The existing home within that identified similar cluster with the highest individual similarity score to the new home may also be obtained.

If it is determined that the new home is most closely associated to a particular one of the existing models, the model of the new home may be initialised with a copy of said existing model. The model for the new home may then go through a refinement process, where it may be modified by considering the weak relational links that are not similar to said existing model. These weak linkages relate to knowledge that cannot be obtained from the selected existing model but can instead be transferred from other models. The knowledge transfer mechanism then identifies which specific knowledge can be extracted from the other models. The new model is then finally trained, with all the appropriate training data, model modifications, transferred parameters, transferred neural network weights, etc. The training data is organised also in the knowledge transfer mechanism, where data can come both from the original data of the new home itself, and from relevant data from across the system of homes.

While the system operates, each individual home model evolves based on events, activities and measurements in the home at hand. When a home evolves its own model, model-update episodes may be assigned a significance score. An update episode considered as significant (in one example, this may be the case when the significance score exceeds a given threshold) can be broadcast to the rest of the system. In one example, the update is broadcast to a main knowledge graph of the system, and the individual members decide if and how to update their own models based on the new knowledge received.

In another example, a further new home may be added to the system, but it is not sufficiently similar to any of the existing models in the knowledge database, meaning that no model can be selected from the central database. In such a case, the system may flag this issue and initialise the further new home with a default model. This default model will then be trained with the data of the further new home and added to the main database of knowledge in the cloud domain.

In another case, where the further new home only has a partial/empty list of features or the features are not comparable with those of the existing homes in the system, making it difficult to compute the similarity scores, the system may again flag this issue. The relevance of the various features within the knowledge bases of all models may then be used to create a model for the further new home. The knowledge transfer mechanism may continue as normal and may attempt to transfer any useful relevant knowledge. It is also possible for no knowledge to be transferred or for no new data to be included in the training step for finalising the further new model. In that scenario, the further new model will be trained solely with the data from the further new home.

The new homes can collect data using a centralised system, within their individual homes, that is connected to the devices/hardware within their respective homes. The centralised system can monitor and maintain the normal operation of the devices within the home as well as take the knowledge transferred to these homes and use it to ensure the safety and proper functioning of the home. For instance, if knowledge is transferred to a home indicating no energy usage, no water consumption and no infrared radiation for a given time period, this may imply that the home is unoccupied. Then the centralised system within the home could use this knowledge to monitor for such an event. When such an event does occur it can automatically turn on a burglary alarm or turn on security cameras, for instance.

The present disclosure beneficially provides a system and methods to share knowledge across a set of machine learning agents, where agents may be clustered by similarity. New agents can benefit from initialising their knowledge based on the trained ML models of related agents in the system. Knowledge learned by an agent may be evaluated for its significance and relevance to other agents. Knowledge evaluated as significant and relevant may be broadcast to other agents, and a selection mechanism allows other agents in the system to decide whether the broadcast knowledge is used to update their own knowledge base or models.

The present disclosure therefore provides faster initialization of the knowledge base of a new agent and the need to maintain accurate and up-to-date knowledge for a set of agents. This can be challenging because it needs to be ensured that the relevant knowledge is transferred between the correct agents, both when a new agent's knowledge base is initialised, and when agents with existing knowledge bases are maintained with up-to-date information. A decision on whether to transfer the knowledge depends on the type of the knowledge and/or the similarity of the agents, where a similarity metric that is applied may depend on the type of knowledge at hand.

1. A transfer learning method for a system, the system comprising:
a plurality of existing agents each including a trained machine learning model for modelling a respective existing machine learning scenario;
a new agent different from the existing agents; and,
a database comprising:
a plurality of available machine learning models for modelling machine learning scenarios, including the plurality of trained machine learning models;
existing scenario metadata indicative of one or more features of the existing machine learning scenarios; and,
transfer learning data indicative of parts of the trained machine learning models associated with respective features of the existing machine learning scenarios,
the method being performed by the new agent, implemented on one or more computer processors, and comprising steps of:
receiving new scenario metadata indicative of one or more features of a new machine learning scenario to be modelled by the new agent;
receiving new scenario training data for training a machine learning model to model the new machine learning scenario;
querying the database to select one of the available machine learning models to be used by the new agent to model the new machine learning scenario, the selection being based on the received new scenario metadata and the existing scenario metadata;
querying the database to select at least some of the transfer learning data to be used by the new agent to train the selected machine learning model, the selection being based on the received new scenario metadata and the existing scenario metadata; and,
training the selected machine learning model using the received new scenario training data and using the selected transfer learning data.

2. A method according to claim 1, wherein querying the database to select one of the available machine learning models comprises:
transmitting the new scenario metadata to the database and, in response, receiving the selected machine learning model from the database; or,
receiving the plurality of available machine learning models and existing scenario metadata from the database, and comparing the new scenario metadata against the existing scenario metadata to select one of the available machine learning models.

3. A method according to claim 1, wherein querying the database to select at least some of the transfer learning data comprises:
transmitting the new scenario metadata to the database and, in response, receiving the selected transfer learning data from the database; or,
receiving the transfer learning data and existing scenario metadata from the database, and comparing the new scenario metadata against the existing scenario metadata to select at least some of the transfer learning data.

4. A method according to claim 1, wherein the database comprises a graph structure linking the existing scenario metadata to the available machine learning models, and wherein the new scenario metadata is compared against the graph structure to select one of the available machine learning models.

5. A method according to claim 4, wherein the graph structure comprises:
a plurality of nodes each representing an entity associated with the existing scenarios; and,
a plurality of edges linking pairs of the entities and representing features of the existing scenarios,
wherein the new scenario metadata is associated with one or more of the nodes by a comparison of features of the new scenario metadata against features represented by the respective edges in order to select one of the available machine learning models.

6. (canceled)

7. A method according to claim 1, wherein the transfer learning data comprises subsets of data each associated with a respective event of the existing scenarios, and wherein selecting at least some of the transfer learning data comprises selecting one or more of the subsets of data based on a comparison between features of the existing and new scenarios.

8. A method according to claim 7, wherein each subset of data comprises at least one of:
hyperparameters of the trained machine learning models associated with the respective event;
neural network weights of the trained machine learning models associated with the respective event; and,
training data used to train the trained machine learning models and associated with the respective event.

9. A method according to claim 1, wherein the system is implemented in a communications network comprising a plurality of edge computing devices and at least one cloud-based computing device, wherein each of the plurality of existing agents and the new agent are implemented in respective edge computing devices and the database is implemented in the at least one cloud-based computing device.

10. A transfer learning method for a system comprising a plurality of agents each implemented on one or more computer processors and each including a trained machine learning model for modelling a respective machine learning scenario, the method being performed by a first agent of the plurality of agents and comprising steps of:
receiving new training data different from previous training data used to train the trained machine learning model currently deployed by the first agent;
retraining the currently-deployed machine learning model using at least the received new training data; and,
comparing the retrained machine learning model against the currently-deployed machine learning model to determine whether to deploy the retrained machine learning model, wherein, if it is determined to deploy the retrained machine learning model, the method further comprises steps of:
identifying transfer learning data, transfer learning data being data associated with the retrained machine learning model that is not associated with the currently-deployed machine learning model; and,
transmitting the identified transfer learning data to a database of the system, the database being accessible by second agents, different from the first agent, of the plurality of agents to retrieve the transmitted data for use in retraining the respective trained machine learning models of the second agents.

11. A method according to claim 10, wherein comparing the retrained and currently-deployed machine learning models comprises determining one or more metrics indicative of performance of the retrained model and comparing against corresponding metrics of the currently-deployed model.

12. A method according to claim 10, wherein identifying transfer learning data comprises identifying data in the received new training data that is different from the previous training data, and wherein the identified different data is identified as transfer learning data if a difference between the identified different data and the previous training data is greater than a prescribed threshold.

13. A method according to claim 10, wherein identifying transfer learning data comprises identifying model weights of the retrained machine learning model different from corresponding model weights of the currently-deployed machine learning model, and wherein the identified model weights are identified as transfer learning data if a change in the identified model weights caused by retraining is greater than a prescribed threshold.

14. A method according to claim 10, the method comprising transmitting scenario metadata to the database along with the identified transfer learning data, the scenario metadata being indicative of a feature of the machine learning scenario being modelled by the first agent associated with the identified transfer learning data.

15. A method according to claim 10, wherein retraining the trained machine learning model comprises using at least some of the previous training data.

16. A transfer learning method for a system comprising a plurality of agents each implemented on one or more computer processors and each including a trained machine learning model for modelling a respective machine learning scenario, the method being performed by a first agent of the plurality of agents and comprising steps of:
querying a database of the system to obtain transfer learning data, the transfer learning data being data not associated with the trained machine learning model that is currently deployed by the first agent;
updating the trained machine learning model of the first agent using the obtained transfer learning data; and,
comparing the updated machine learning model against the currently-deployed machine learning model, and determining whether to deploy the updated machine learning model based on the comparison.

17. A method according to claim 16, wherein the obtained transfer learning data is new training data different from previous training data used to train the currently-deployed machine learning model, and wherein updating the trained machine learning model comprises retraining the trained machine learning model to obtain the updated machine learning model.

18. (canceled)

19. A method according to claim 16, wherein the obtained transfer learning data is one or more updated parameters of the machine learning model different from corresponding parameters of the currently-deployed machine learning model, and wherein updating the trained machine learning model comprises replacing one or more parameters in the trained machine learning model with the corresponding received updated parameters.

20. A method according to claim 16, wherein comparing the updated and currently-deployed machine learning models comprises determining one or more metrics indicative of performance of the updated model and comparing against corresponding metrics of the currently-deployed model.

21. A non-transitory, computer-readable storage medium storing instructions thereon that when executed by one or more computer processors cause the computer processors to execute the method of claim 1.

22. A computing device comprising one or more processors configured to perform the method of claim 1.
